(19) United States
(12) Patent Application Publication
(10) Pub. No.: US 2012/0182833 A1
(43) Pub. Date: Jul. 19, 2012

(54) ULTRASONIC ID READER

(76) Inventors: Frans Lautzenhiser, Zionsville, IN (US); Alex Mezheritsky, Zionsville, IN (US); Patrick E. Gwin, Indianapolis, IN (US); Steven T. Morris, Indianapolis, IN (US); Richard W. Smith, Richland, WA (US); Brian E. Atkinson, Fishers, IN (US)

(21) Appl. No.: 13/314,855

(22) Filed: Dec. 8, 2011

Related U.S. Application Data
(60) Provisional application No. 61/421,755, filed on Dec. 10, 2010.

(51) Int. Cl. G01S 15/88

(52) U.S. Cl. 367/87

(57) ABSTRACT

A method for identifying a warhead in an aircraft launch tube includes providing a pattern of grooves on the surface of a warhead, with the pattern of grooves being associated with an identification code identifying the warhead or a characteristic of it, providing the warhead in an aircraft launch tube, providing a piezoelectric transducer on the launch tube, emitting an ultrasonic wave from the piezoelectric transducer to the pattern of grooves, where the wave encounters the pattern of grooves at an angle of less than 90° so that waves striking the interior of a groove are reflected back to the transducer as echo waves, while waves not striking the interior of a groove are reflected away from the transducer, and reading the pattern of returning echo waves to determine the identification code indicated by the pattern of grooves on the warhead.

### CROSS-REFERENCE TO RELATED APPLICATIONS

This application claims the benefit of U.S. Provisional Patent Application Ser. No. 61/421,755, filed Dec. 10, 2010, the entire contents of which are hereby incorporated herein by reference.

### BACKGROUND

Military aircraft may be armed with rockets contained in pods for rapid firing. Each pod may carry 7 to 19 rockets. Since the rockets may have been loaded under extreme stress, or at night, or in inclement weather, or on a carrier or other ship engaged in battle, a manual inventory may not be possible or accurate. Thus, a pilot may not know which of several possible warhead types are available to fire.

A variety of optical or electromagnetic systems for identifying warheads in an aircraft launch tube have been evaluated. Such systems have not proven reliable, particularly under the high-stress, high-temperature, small-space conditions of a military aircraft.

A need therefore exists for a device and method that permits pilots to determine from the cockpit what rockets are loaded in their aircraft launch tubes. The present invention addresses that need.

### SUMMARY OF THE INVENTION

Briefly describing one aspect of the present invention, there is provided a method for identifying a warhead in an aircraft launch tube. The method includes:

a) providing a pattern of grooves on the surface of a warhead, with the pattern of grooves being associated with an identification code identifying the warhead or a characteristic of it;

b) providing the warhead in an aircraft launch tube;

c) providing a piezoelectric transducer on the launch tube;

d) emitting an ultrasonic wave from the piezoelectric transducer to the pattern of grooves, wherein the wave encounters the pattern of grooves at an angle of less than 90° so that waves striking the interior of a groove are reflected back to the transducer as echo waves, while waves not striking the interior of a groove are reflected away from the transducer, and

e) reading the pattern of returning echo waves to determine the identification code indicated by the pattern of grooves on the warhead.

### BRIEF DESCRIPTION OF THE DRAWINGS

FIG. 1 shows one embodiment of the inventive device.

FIG. 2 shows an alternative groove shape that may be used in other embodiments of the present invention.

FIG. 3 shows another alternative groove shape that may be used in other embodiments of the present invention.

### DESCRIPTION OF THE INVENTION AND ITS PREFERRED EMBODIMENTS

For the purposes of promoting an understanding of the principles of the invention, reference will now be made to certain preferred embodiments and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. The present invention provides a device and method for detecting an identification (ID) code pattern machined, stamped or otherwise formed on the surface of an object such as a military warhead loaded in an aircraft rocket launch tube. Preferably, a single ultrasonic transducer is provided at a substantially fixed position with respect to the ID pattern, and an ultrasonic wave is pulsed against the pattern. The returning echo waves are received and read to determine the ID pattern on the object.

A typical pattern may include a set of parallel grooves having a known, repetitive spacing. At each spacing interval a groove may or may not be present. For example, the presence of a groove may be associated with the number “1,” and the absence of a groove may be associated with the number “0”. A pattern of grooves can then in that manner indicate a simple binary number.

The binary number can be detected using a short pulse of ultrasound. To accomplish this, the transducer is oriented so that a pulse from the transducer strikes the pattern at an appropriate angle from above the pattern. In the plane of the pattern the ultrasound strikes the grooves at a perpendicular angle. The profile of the grooves is such that ultrasound that strikes a groove will be reflected back to the transducer. If a groove is not present the ultrasound will be reflected away from the transducer.

Echoes returning from the pattern are separated in time, with echoes from progressively more distant grooves returning at a progressively later time. By time gating the returning echoes it is possible to derive a simple binary number, or code.

One advantage of the present invention is that it provides a way for a military pilot to quickly generate an inventory and store it automatically into a computer after the rockets are loaded into the pod. No member of the crew needs to do a time consuming, manual inventory of the rockets.

The simplicity of the system is also an advantage. Only one single-element ultrasonic transducer is required to read the warhead ID tag if all warheads are similarly sized. Additionally, only one coaxial cable is required per transducer. In embodiments in which rockets of different lengths may be loaded, each tube in the pod may require two or more transducers to accommodate rockets of different lengths. This contrasts to systems in which arrays of transducers are used for each warhead. In that case, many more transducers and cables may be required.

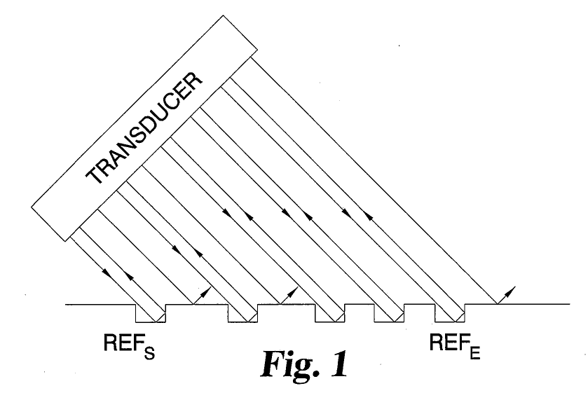

FIG. 1 shows one preferred embodiment of the inventive device. In FIG. 1, the grooves are cut perpendicularly to the surface of the object to be identified, with the illustrated grooves having a “rectangular” or “box cut” shape.

The groove pattern in FIG. 1 begins with a “start” reference groove “REF_{S}”, and ends with an “end” reference groove “REF_{E}”. The “start” and “end” reference grooves indicate to the ID reader that the pattern is beginning and ending, respectively. The grooves between the “start” and “end” reference grooves are therefore understood by the reader to contain identification information.

As discussed above, the transducer is positioned above the surface at an angle such that ultrasonic beam intercepts the grooves at an angle. Beams/waves that enter a groove are reflected back to the transducer, while beams/grooves that do not enter a groove are reflected away. The travel time of the ultrasonic waves reflected back from the closest grooves is shorter, while the travel time of the ultrasonic waves reflected back from the grooves further away is slightly longer.

If no groove is present, the ultrasound striking the pattern in that region is deflected away from the transducer. If a groove is present the sound is reflected back to the transducer at the same angle as the incident wave.

Accordingly, it can be seen that FIG. 1 shows the returning echo pattern and the binary number (01011) for the groove pattern shown.

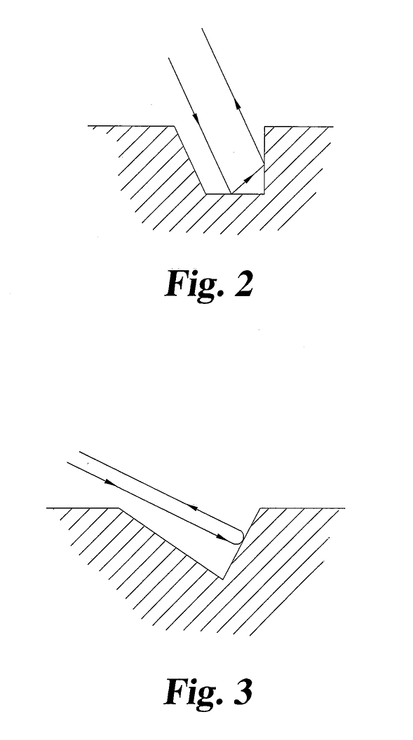

The groove profile may be modified to enhance performance. If the incident wave angle and direction is known, the groove may be modified as shown in FIG. 2 or FIG. 3.

FIG. 2 shows an alternative groove shape that may be used in other embodiments of the present invention. In FIG. 2, the leading face of each groove is “cut” or angled rather than being perpendicular to the surface of the object.

FIG. 3 shows another alternative groove shape that may be used in other embodiments of the present invention. In FIG. 3, a two-surface “tipped” or angled groove is used instead of the three-surface “box” groove of FIG. 1. The “tipped” or angled groove is still effective for reflecting ultrasonic waves back to the transducer to indicate the presence or absence of the groove.

In the preferred embodiments each transducer is provided at a fixed and known distance from the surface of the object to be read. For example, distances of about 2.5 inches have been effective in testing to date. In other embodiments each transducer may be provided at a variable distance from the object, with the distance preferably being within a narrow distance range.

Similarly, in the preferred embodiments each transducer is provided at a fixed and known angle relative to the surface of the object to be read. Angles much less than 90° are shown in the example of FIG. 1 to ensure the desired effect of having waves that do not encounter a groove to be reflected away from the transducer. In the illustrated embodiment, the angle is approximately 45° when measured from the surface over which the beam travels (i.e., from the left in FIG. 1). Angles of between 30° and 60° may be used in other embodiments, depending on the configuration, the spacing of the grooves in the code, and the distance between the transducer and the grooves. Angles approaching 90° may also be used. In some embodiments the transducer provides a beam that strikes the grooved surface at an angle of less than 80°, and preferably less than 70°

As previously indicated, the groove pattern is chosen to have “start” and “stop” grooves present with additional grooves either occurring or not occurring at a fixed interval between the end grooves. This allows the echo time spacing to vary widely with temperature, pressure or when being disturbed by incident air currents. The digitized echoes can be processed by a computer to time align the disturbed or varied echo arrivals which can then be averaged over time to provide a high signal noise ratio for robust identification.

The pattern of grooves may be provided in the surface of the object to be identified by any method effective for providing grooves. For example, laser etching may be used. Groove depths of approximately 0.025″ have been successfully tested in the example shown, however this could be smaller or significantly larger depending on the needs of a particular application.

The pattern of grooves may be used to identify the object in which the grooves are provided, or any characteristic or feature of the object. For example, the grooves may be used to identify the type or model of a warhead, or any feature or characteristic of the warhead.

Though the described application is for operation in air, the present invention may also be used in other media, such as drilling mud or nuclear reactor coolants (liquid sodium or lead bismuth eutectic). It can also be employed effectively in a contact mode.

In some preferred embodiments the transducer used in the device has a front face that is a good intermediate impedance match between air and the composite element. Moreover, it is preferred in some embodiments that this front face is heat and flame blast resistant. These attributes are particularly valuable when the device is to be used to identify missiles or rockets to be launched from a military aircraft.

Among the other potential applications that are envisioned for the inventive ultrasonic ID reader are:

Security systems, particularly where the ID tag pattern must be hidden. If necessary the tag can be read from the back side of the pattern.

Down hole applications, where drilling mud obscures an object visually.

Identifying the fuel assemblies in a liquid metal cooled nuclear reactor. The opaque coolant prevents visualizing the fuel assemblies as well as all other internal components. Ultrasonic imaging may be used to read the ID numbers from a visual image of the fuel assembly handling socket. That may be backed up by a binary code machined into the rim of the socket that is read by a “clicker” on the fuel handler.

1. A method for identifying a warhead in an aircraft launch tube, comprising:
a) providing a pattern of grooves on the surface of a warhead, wherein said pattern of grooves is associated with an identification code identifying said warhead or a characteristic thereof;
b) providing said warhead in an aircraft launch tube;
c) providing a piezoelectric transducer on said launch tube;
d) emitting an ultrasonic wave from said piezoelectric transducer to said pattern of grooves on said warhead, wherein said wave encounters said pattern of grooves at an angle of less than 90° so that waves striking the interior of a groove are reflected back to the transducer as echo waves, while waves not striking the interior of a groove are reflected away from the transducer;
e) reading the pattern of returning echo waves to determine the identification code indicated by the pattern of grooves on the warhead.

2. The method of claim 1 wherein said transducer is a single-element transducer.
